(19) United States
(12) Patent Application Publication
(10) Pub. No.: US 2018/0268361 A1
(43) Pub. Date: Sep. 20, 2018

(54) SYSTEMS AND METHODS TO ENABLE SHIPPING OF COMMERCIAL PRODUCTS

(71) Applicant: Walmart Apollo, LLC, Bentonville, AR (US)

(72) Inventors: Todd D. Mattingly, Bentonville, AR (US); Greg A. Bryan, Centerton, AR (US); Benjamin D. Enssle, Bella Vista, AR (US); Cristy C. Brooks, Cassville, MO (US); David C. Winkle, Bella Vista, AR (US)

(21) Appl. No.: 15/921,295

(22) Filed: Mar. 14, 2018

Related U.S. Application Data
(60) Provisional application No. 62/471,212, filed on Mar. 14, 2017.

(51) Int. Cl. G06Q 10/08; G06K 19/06

(52) U.S. Cl. CPC G06Q 10/0833; G06Q 10/087; G06K 19/06028

(57) ABSTRACT

In some embodiments, systems and methods are provided herein useful to enable shipping of commercial products. In some embodiments, systems are provided to enable shipping of commercial products, comprises: a conveyor positioned proximate to commercial product entry points and communicatively coupled to control circuits, conveyable containers each configured to traverse the commercial product entry points via the conveyor and comprising a volume configured to hold commercial products, and sensors positioned proximate to the volume and communicatively coupled to the control circuits. The control circuits use the sensors to receive authenticating data associated with commercial products when a commercial product undergoes a positional event at a commercial product entry point. The control circuits confirm associations between received authenticating data and conveyable containers. In some embodiments, the control circuits generate a notification of the positional event when the association is confirmed.

### CROSS-REFERENCE TO RELATED APPLICATION

This application claims the benefit of U.S. Provisional Application No. 62/471,212, filed Mar. 14, 2017, which is incorporated herein by reference in its entirety.

### TECHNICAL FIELD

This invention relates generally to shipping commercial products.

### BACKGROUND

Warehouse management systems (“WMS”) are software applications that typically support the day-to-day operations in a warehouse. A WMS program can enable centralized management of tasks such as tracking inventory levels and stock locations. WMS systems may be standalone or part of enterprise resource planning systems. WMS systems may employ tracking and routing technologies. In general, WMS can provide information to efficiently control movement of commercial products within a warehouse.

### BRIEF DESCRIPTION OF THE DRAWINGS

Disclosed herein are embodiments of systems and methods pertaining to shipping commercial products. This description includes drawings, wherein:

FIG. 1 illustrates a simplified block diagram of a system for enabling shipping of commercial products, in accordance with some embodiments.

FIG. 2 is a flowchart of an exemplary process of enabling shipping of commercial products, in accordance with several embodiments.

FIG. 3 illustrates an exemplary system for use in implementing methods, techniques, devices, apparatuses, systems, servers, sources and enabling the shipping of commercial products, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some embodiments seek to facilitate the management of warehouse and/or distribution center operations by addressing a plurality of issues, including but not limited to over shipment, missed shipment, shipment accuracy, pallet loading, handling exceptions, and/or rational loading of delivery vehicles.

Generally speaking, pursuant to various embodiments, systems and methods are provided herein useful to enable shipping of commercial products. In some embodiments, systems are provided to enable shipping of commercial products, and comprise: a conveyor positioned proximate to a plurality of commercial product entry points and communicatively coupled to one or more control circuits, one or more conveyable containers each configured to traverse the commercial product entry points via the conveyor and comprising a volume configured to hold commercial products, and one or more sensors each positioned proximate to the volume and communicatively coupled to the one or more control circuits. The one or more control circuits use the sensors to receive authenticating data associated with commercial products when a commercial product undergoes a positional event relative to a volume positioned at a commercial product entry point. The one or more control circuits confirm an association between the received authenticating data and the conveyable container. In some embodiments, the one or more control circuits generate a notification of the positional event when the association is confirmed, wherein the positional event is the placement of the commercial product into the volume or removal of the commercial product from the volume.

In other embodiments, methods are provided for enabling shipping of commercial products. Some of these methods receive, via one or more control circuits, authenticating data associated with one or more commercial products when one of the commercial products undergo a positional event relative to a volume positioned at a commercial product entry point, wherein the volume is configured to hold commercial products. One or more associations between the received authenticating data and conveyable containers may be confirmed. Notifications of positional events may be generated. The positional event may be the placement of the commercial product in the volume or removal of the commercial product from the volume. Commercial product entry points may be positioned proximate to a conveyor.

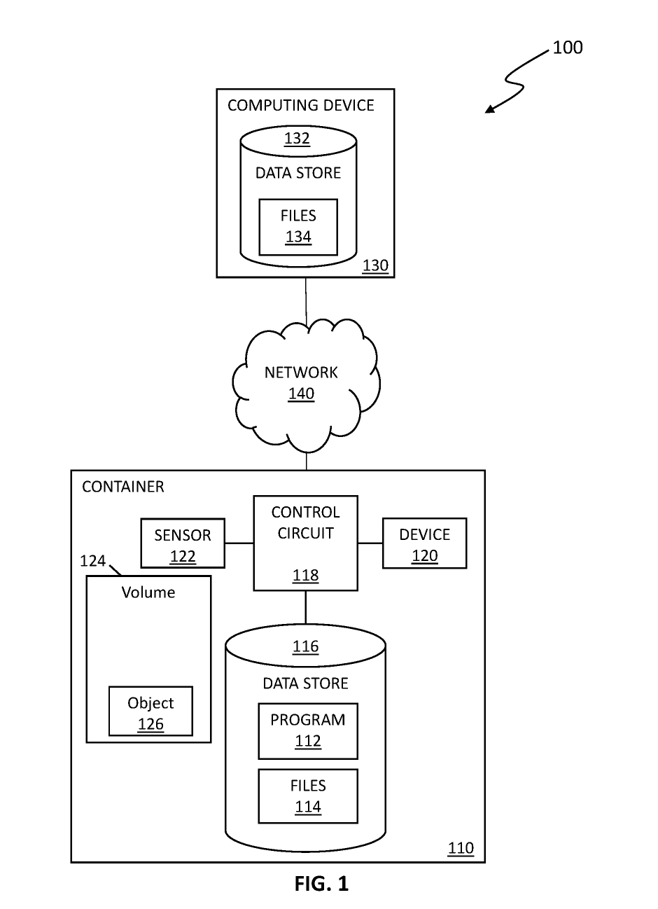

FIG. 1 illustrates a simplified block diagram of a system 100 for enabling shipping of commercial products, in accordance with some embodiments. System 100 may comprise one or more computing devices 130 and one or more containers 110 configured to communicate over a computer and/or one or more communication networks 140. Network 140 can be, for example, a local area network (LAN), a wide area network (WAN) such as the Internet, or a combination of the two, and includes wired, wireless, fiber optic connections, other such connections, or combination of two or more of such types of connections. In general, network 140 can be any combination of connections and protocols that can support communications between computing device 130 and container 110, in accordance with some embodiments.

Computing device 130 is a device that supports warehouse management activities, in accordance with several embodiments. For example, warehouse management activities can include tracking inventory levels, tracking stock locations, similar warehouse management activities, or a combination of two or more thereof. Computing device 130 can be or can include one or more of a desktop computer, laptop computer, a thin client, a wearable computing device, a mobile device (e.g., smart phones, phablets, tablets, and similar devices), and/or other such devices. Computing device 130 can comprise data store 132, which is an information repository that can comprise files 134.

Files 134 can comprise data that can be used to authenticate one or more commercial products (e.g., identification information, weight values, dimensions, container associations, associated commercial product entry point, similar authenticating data, or a combination of two or more thereof). Files 134 can further comprise data that describes the preferred contents of one or more containers 110 (e.g., container identification information, commercial product associations, similar data, or a combination of two or more thereof). Data store 132 can receive data from one or more external data sources or can receive data via one or more input devices (e.g., keyboards, mice, microphones, touchscreens, similar input devices, or a combination of two or more thereof) that are communicatively coupled to computing device 130. Alternatively or additionally, data store 132 can receive data from container 110 (discussed further below).

Container 110 is a conveyable apparatus that can store one or more commercial products, in accordance with several embodiments. Warehouses and distribution centers, for example, typically house a plurality of commercial products, which may be picked and handled as individual units and placed in containers, such as container 110, prior to shipping. Containers may traverse between two or more locations via one or more conveyor systems. Such conveyor systems can include on or more belt driven roller conveyors, flexible conveyors, gravity skatewheel conveyors, belt conveyors, wire mesh conveyors, plastic belt conveyors, bucket conveyors, flexible conveyors, vertical conveyors, spiral conveyors, vibrating conveyors, pneumatic conveyors, electric track vehicles systems, belt driven live roller conveyors, lineshaft roller conveyors, chain conveyors, screw conveyors, auger conveyors, chain driven live roller conveyors, overhead I-beam conveyors, dust proof conveyors, pharmaceutical conveyors, automotive conveyors, overland conveyors, drag conveyors, similar conveyors systems, or a combination of two or more thereof. Commercial products typically comprise authenticating data that conveys descriptive information associated with the product to which it is affixed, such as (e.g., name, unique identifier, manufacturer, place of origin, similar information, or a combination of two or more thereof). For example, one or more unique identifiers can be affixed to one or more surfaces of commercial products. Authenticating data may be included in images (e.g., human visual spectrum, UV, and/or similar spectra) and/or electromagnetic signals.

As will be explained further below, authenticating data can be utilized to identify commercial products and confirm the proper placement of identified commercial products in the container 110. Container 110 includes one or more volumes 124 each configured to receive one or more commercial object 126. Container 110 may comprise one or more sensors 122, one or more output devices 120, and one or more data stores 116 each in communication with one or more control circuits 118. In certain embodiments, control circuits 118, sensors 122, output devices 120, data stores 116, or a combination of two or more thereof may be temporarily affixed to container 110. The one or more control circuits 118 are configured (for example, by using corresponding programming as will be well understood by those skilled in the art) to carry out one or more of the steps, actions, and/or functions described herein.

Typically, one or more sensors 122 are positioned proximate to the volume 124 of container 110. In some embodiments, one or more sensors 122 can be positioned proximate to the conveyor. Sensors 122, for example, may be positioned proximate to one or more surfaces of the volume in a manner to facilitate the capture of identification data. Sensors 122 can capture one or more images (e.g., regular, thermal, UV, similar spectrums, or a combination of two or more thereof), capture video, capture wireless signals, transmit wireless signals, scan optical representations of unique identifying data (e.g., barcodes and similar markings), capture and/or measure acceleration data, capture temperature readings, capture weight values, capture geolocation data, perform similar functionalities, or a combination of two or more thereof.

Output devices 120 are computing devices that can present audible and/or visual storage information corresponding to volume 124, in accordance to certain embodiments. Output devices 120 can comprise one or more output devices that emit audible signals (e.g., speakers, horns, similar output devices, or a combination of two or more thereof). In certain embodiments, output devices 120 can emit signals that are detectable within a threshold distance relative to container 110. Alternatively or additionally, output devices 120 can comprise one or more output devices that present visual signals (e.g., lights, displays, touch screen display, similar output devices, or a combination of two or more thereof). In some embodiments, output devices 120 can comprise one or more devices that provide tactile feedback (e.g., forces, vibrations, motions, or a combination of two or more thereof). Although not shown, container 110 may comprise one or more power sources that can energize sensors 122, output devices 120, control circuits 118, or a combination of two or more thereof.

Data store 116 can comprise an information repository that may comprise program 112, files 114, other such information, or a combination of two or more thereof. In certain embodiments, data store 116 can be integral to container 110 or may be physically discrete (in whole or in part) from container 110. Data store 116 may also be local with respect to container 110 (where, for example, both share a chassis, power supply, and/or housing) or can be partially or wholly remote with respect to container 110 (where, for example, data store 116 is physically located in another facility, metropolitan area, or even country as compared to container 110. Files 114 may comprise authenticating data captured by sensors 122 (“captured data”). Files 114 may comprise data received from computing device 130 (“received data”). For example, received data can comprise authenticating data included in files 134. For example, files 114 may comprise a listing of one or more commercial products that are associated with the container 110, wherein the listing may describe the one or more commercial products via one or more types of authenticating data (e.g., unique identifiers, weight values, commercial product entry points, similar authenticating data, or a combination of two or more thereof). In some instances, the files may further include historic data, movement data, tracking data, sensor data, threshold data, and/or other such information. Some or all of the files are accessible by the control circuit and/or can be communicated via a wired and/or wireless transceiver of the container 110.

Program 112 is software that is implemented by the control circuit such that the control circuit authenticates and/or monitors the contents of container 110, in accordance with certain embodiments. In some embodiments, the control circuit receives data from the computing device 130 and can utilize some or all of that data and/or cause some or all of that data to be stored in one or more files 114. For example, commercial product identifying data of one or more commercial products may be received that are intended to be positioned in one or more volumes 124. In some instances, control circuits 118, invoking programs 112, to transmit a request to computing device 130, via network 140, for data included in files 134 that lists the commercial products that are associated with container 110. Upon receipt control circuits 118, invoking one or more programs 112, stores the requested data in one or more files 114. In certain embodiments, container 110 can be positioned on a conveyor, which may be positioned proximate to one or more commercial product entry points, which comprise one or more locations at a facility where one or more commercial products are deposited into the one or more volumes 124. At each product entry point, container 110 can undergoes one or more positional events. Positional events can include, but are not limited to, one or more commercial products being placed in the volume 124 of container 110, removed from a volume, positionally shifted within a volume (e.g., moved a distance, laid down, moved on top of another commercial product within the volume, etc.) moved to a different volume within the container, acceleration of a product greater than a threshold, and/or other such positional events.

Control circuits 118 can receive one or more triggering events from sensors 122 when a commercial product undergoes a positional event. For example, control circuits 118 can instruct the sensors 122 to generate one or more triggering events when the sensors 122 detect motion within the one or more volumes 124. For example, one or more sensors 122 can emit and capture a wireless signal (e.g., light, sound, microwave, and similar wireless signals) to detect motion. In response to receiving the triggering event, control circuits 118 can instruct one or more sensors 122 to capture authenticating data associated with the received commercial product. In embodiments wherein authenticating data is presented by visual symbols affixed to commercial products, control circuits 118 can instruct sensors 122 to capture one or more images of the received commercial product, determine the visual symbols included in the one or more captured images having a threshold relationship with a unique identifier, and convert the determined visual symbols to machine readable text and/or code.

In embodiments where commercial products emit authenticating data via wireless signals, control circuits 118 can instruct the sensors 122 to capture the wireless signals. Additionally or alternatively, control circuits 118 can instruct the sensors 122 to capture a weight value associated with the received commercial product. Here, the weight value can reflect the mass increase experienced by the container 110 as a result of the positional event. Some embodiments may detect a change in weight within the volume or absence of a weighted product within the volume. In certain embodiments, control circuits 118 can further instruct sensors 122 to capture geospatial data that reflects the location of positional events (i.e., the location of the container when a commercial product is received by or removed from the volume). In certain embodiments, the captured geospatial data may be used to facilitate the authentication and/or monitoring of the contents of container 110. By one approach, the captured geospatial data can be used to ascertain whether the container 110 proceeded to the appropriate commercial product entry points. In some embodiments, authenticating data can be captured and stored in files 114.

Control circuits 118 can confirm that the captured authenticating data corresponds to data included in files 114 (i.e. the received commercial product is intended to be associated with the container 110) by comparing the captured authenticating data with the received authenticating data from the computing device 130. For example, an association between the received commercial product and container 110 can be confirmed when one or more types of captured authenticating data are determined to be included in the received authenticating data. In some instances, control circuits 118 can compare the captured authenticating data included in the captured wireless signal, the machine readable text, and/or other such authenticating data to the received authenticating data included in files 114 (discussed above) to confirm that an entry included in the received authenticating data reflects the captured authenticating data. In certain embodiments, control circuits 118 can further compare additional types of captured authenticating data (e.g., the captured weight value, captured geospatial data, or a combination of the two) to the received authenticating data to confirm that such data is included in the captured authenticating data. In other embodiments, control circuits 118, invoking programs 112, can transmit captured authenticating data to computing device 130 to confirm that the captured authenticating data corresponds to information included in files 134 for container 110.

In response to confirming an association between the received commercial product and container 110, control circuits 118 can generate a notification (e.g., “notification A”) that reflects the desired receipt of the commercial product by container 110. For example, notification A can comprise a confirmation message that reflects commercial product ID, container ID, weight, date, time, geospatial data, similar confirming data, or a combination of two or more thereof. In some embodiments, in response to failing to confirm an association between the received commercial product and container 110 (i.e., no association between the captured authenticating data and the received authenticating data), control circuits 118, invoking programs 112, can generate a notification (e.g., “notification B”). For example, notification B can comprise an error message that reflects commercial product ID, container ID, date, time, geospatial data, similar confirming data, or a combination of two or more thereof.

In other embodiments, control circuits 118 can instruct output devices 120 to present one or more generated notifications via output devices 120 (e.g., via text, one or more images, video, audio, other similar outputs, or a combination of two or more thereof), which allows a user to confirm the proper receipt of a commercial product without the need to inspect the contents of the volume. Additionally or alternatively, control circuits 118 can instruct a transceiver to transmit one or more generated notifications to computing device 130. In certain embodiments, control circuits 118 can instruct output devices 120 to present information about the commercial products included in the volume of container 110 (e.g., via text, one or more images, video, similar output, or a combination of the two) via one or more devices 120, which can allow a user to view the contents of the container 110 without the need to visual inspect each commercial product included in the volume. By one approach, authentication data, generated notifications, confirmations, similar information, or a combination of two or more thereof may be presented via one or more devices 120.

Container 110 may experience an acceleration event (i.e., fall off or tip over) while traversing the conveyor. In some embodiments, control circuits 118 can instruct sensors 122 to capture one or more acceleration readings that are above a threshold value and generate a notification (e.g., “notification C”) that includes the captured accelerations readings. For example, notification C can include one or more tones, prerecorded messages, prerecorded videos, similar warning alerts, or a combination of two or more thereof. In response to generating notification C, control circuits 118 can instruct output device 120 emit and/or present the generated notification C.

For example, one or more commercial products may fall out of the volume (i.e., undergo a positional event) if the container falls off of the conveyor (i.e., undergoes an acceleration event). In certain embodiments, in response to generating notification C, control circuits 118 can instruct sensors 122 to capture an updated weight value for container 110 and compare the captured updated weight value to the weight value of container 110 prior to the acceleration event to determine whether one or more commercial products are missing from the volume. For example, if control circuits 118 determine that the difference between the captured updated weight value and the weight value prior to the acceleration event is above a threshold amount, then one or more commercial products are missing from the volume. In such an event, control circuits 118 can generate a notification (“notification D”) of the weight difference and convey the generated notification as discussed above.

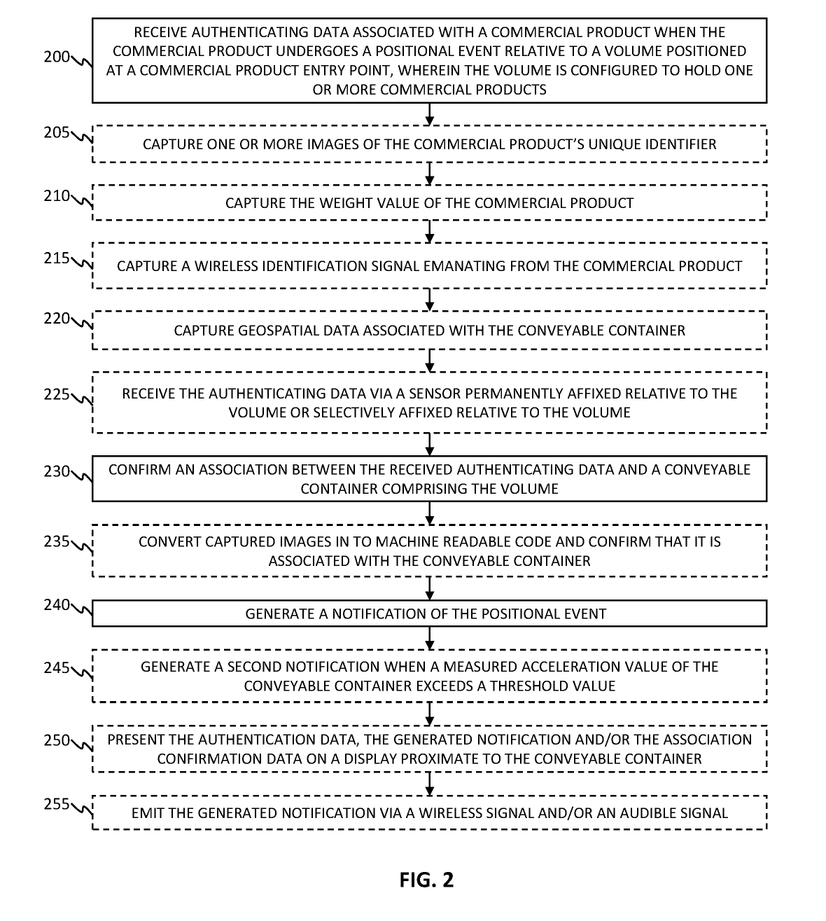

FIG. 2 is a flowchart of an exemplary process of enabling shipping of commercial products, in accordance with several embodiments. At block 200 the control circuits 118 can receive authenticating data associated with a commercial product when the commercial product undergoes a positional event relative to a volume 124 positioned at a commercial product entry point. By one approach, and as illustrated, the volume 124 is configured to hold one or more commercial products. At optional block 205, one or more sensors 122 can capture one or more images of the commercial product's unique identifier. The one or more sensors can capture the weight value of the commercial product, at optional block 210. The one or more sensors 122 can capture a wireless signal emanating from the commercial product, at optional block 215. The one or more sensors 122 can capture geospatial data associated with the conveyable container 110, at optional block 220. At optional block 225, authentication data can be received via a sensor permanently affixed relative to the volume 124 or selectively affixed relative to the volume 124. At block 230, the control circuits 118 can confirm an association between the received authenticating data and the container 110 comprising the volume 124.

The control circuits 118 converts captured images in to machine readable code and confirms that the code is associated with the conveyable container, at optional block 235. At block 240, the control circuits 118 generate a notification of the positional event. By one approach, the control circuits 118 generate a second notification when a measured acceleration value of the conveyable container exceeds a threshold value, at optional block 245. The control circuits 118 presents the authenticating data, the generated notification, and/or the association confirmation data on a display proximate to the conveyable container, at optional block 250. In certain embodiments, at optional block 255, the control circuits 118 emit the generated notification via a wireless signal and/or an audible signal.

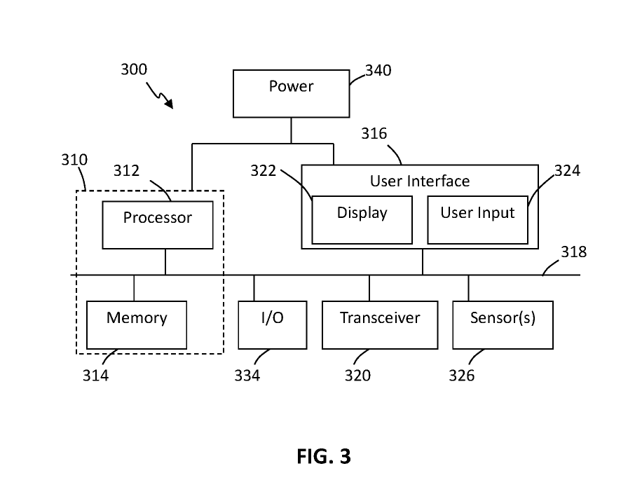

Further, the circuits, circuitry, systems, devices, processes, methods, techniques, functionality, services, servers, sources and the like described herein may be utilized, implemented and/or run on many different types of devices and/or systems. FIG. 3 illustrates an exemplary system 300 that may be used for implementing some or all of any of the components, circuits, circuitry, systems, functionality, apparatuses, processes, or devices of the container 110, the control circuit 118 of the container 110, the computing device 130, and/or other above or below mentioned systems or devices, or parts of such circuits, circuitry, functionality, systems, apparatuses, processes, or devices. For example, the system 300 may be used to implement some or all of the container 110, the control circuit 118, one or more other control circuits and/or processing systems of the container 110 (e.g., video processing systems, image processing systems, sensor data processing systems, emitter system, and the like), one or more control and/or processing systems of the computing device 130, one or more remote central control systems, sensors 122, output devices 120, and/or other such components, circuitry, functionality and/or devices. However, the use of the system 300 or any portion thereof is certainly not required.

By way of example, the system 300 may comprise a control circuit or processor module 312, memory 314, and one or more communication links, paths, buses or the like 318. Some embodiments may include one or more user interfaces 316, and/or one or more internal and/or external power sources or supplies 340. The control circuit 312 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. By one approach, the control circuit 312 can implement some or all of aforementioned functionalities of control circuits 118. Further, in some embodiments, the control circuit 118 can be part of control circuitry and/or a control system 310, which may be implemented through one or more processors with access to one or more memory 314 that can store instructions, code and the like that is implemented by the control circuit and/or processors to implement intended functionality. In some applications, the control circuit and/or memory may be distributed over a communications network 140 (e.g., LAN, WAN, Internet) providing distributed and/or redundant processing and functionality. Again, the system 300 may be used to implement one or more of the above or below, or parts of, components, circuits, systems, processes and the like.

The user interface 316 can allow a user to interact with the system 300 and receive information through the system. In some instances, the user interface 316 includes a display 322 and/or one or more user inputs 324, such as buttons, touch screen, track ball, keyboard, mouse, etc., which can be part of or wired or wirelessly coupled with the system 300. By one approach, user interface 316 can implement some or all of the functionality, techniques, and/or processes of device 120. Typically, the system 300 further includes one or more communication interfaces, ports, transceivers 320 and the like allowing the system 300 to communicate over a communication bus, a distributed computer and/or communication network 140 (e.g., a local area network (LAN), the Internet, wide area network (WAN), etc.), communication link 318, other networks or communication channels with other devices and/or other such communications or combination of two or more of such communication methods. Further the transceiver 320 can be configured for wired, wireless, optical, fiber optical cable, satellite, or other such communication configurations or combinations of two or more of such communications. Some embodiments include one or more input/output (I/O) ports 334 that allow one or more devices to couple with the system 300. The I/O ports can be substantially any relevant port or combinations of ports, such as but not limited to USB, Ethernet, or other such ports. The I/O interface 334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system 300 may include one or more sensors 326 and/or implement some or all of one or more of the sensors 122 to provide information to the system and/or sensor information that is communicated to another component, such as to the control circuit 118, the computing device 130, a central control system, a delivery vehicle, etc. The sensors can include substantially any relevant sensor, such as distance measurement sensors (e.g., optical units, sound/ultrasound units, etc.), cameras, motion sensors, inertial sensors, accelerometers, impact sensors, pressure sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 300 comprises an example of a control and/or processor-based system with the control circuit 312. Again, the control circuit 312 can be implemented through one or more processors, controllers, central processing units, logic, software and the like. Further, in some implementations the control circuit 312 may provide multiprocessor functionality.

The memory 314, which can be accessed by the control circuit 312, typically includes one or more processor readable and/or computer readable media accessed by at least the control circuit 312, and can include volatile and/or nonvolatile media, such as RAM, ROM, EEPROM, flash memory and/or other memory technology. Further, the memory 314 is shown as internal to the control system 310; however, the memory 314 can be internal, external or a combination of internal and external memory. Similarly, some or all of the memory 314 can be internal, external or a combination of internal and external memory of the control circuit 312. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 140. The memory 314 can store code, software, executables, scripts, data, content, lists, programming, programs, log or history data, user information, customer information, product information, and the like. While FIG. 3 illustrates the various components being coupled together via a bus, it is understood that the various components may actually be coupled to the control circuit and/or one or more other components directly.

In some embodiments, systems are provided to enable shipping commercial products, comprises: a conveyor positioned proximate to a plurality of commercial product entry points and communicatively coupled to one or more control circuits, one or more conveyable containers each configured to traverse the commercial product entry points via the conveyor and comprising a volume configured to hold commercial products, and one or more sensors each positioned proximate to the volume and communicatively coupled to the one or more control circuits. The one or more control circuits use the sensors to receive authenticating data associated with one or more commercial products when the commercial products undergo a positional event relative to a volume positioned at a commercial product entry point. The one or more control circuits confirm an association between the received authenticating data and the conveyable container. In some embodiments, the one or more control circuits generate a notification of the positional event when the association is confirmed, wherein the positional event is consist of placement of the commercial product into the volume or removal of the commercial product from the volume.

In other embodiments, methods are provided for enabling shipping of commercial products. Some of these methods receive, via one or more control circuits, authenticating data associated with one or more commercial products when each of the commercial products undergo a positional event relative to a volume positioned at a commercial product entry point, wherein the volume is configured to hold commercial products. One or more associations between the received authenticating data and one or more conveyable containers may be confirmed. One or more notifications of the positional events may be generated. Positional events may be placement of the commercial product in the volume or removal of the commercial product from the volume. Commercial product entry points may be positioned proximate to a conveyor.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to enable shipping commercial products, comprising:
a conveyor positioned proximate to a plurality of commercial product entry points and communicatively coupled to one or more control circuits;
a conveyable container configured to traverse the plurality of commercial product entry points via the conveyor and comprising a volume configured to hold one or more commercial products;
one or more sensors positioned proximate to the volume and communicatively coupled to the one or more control circuits; and
wherein the control circuit is configured to:
receive, via the one or more sensors, authenticating data associated with a commercial product when the commercial product undergoes a positional event relative to the volume positioned at a commercial product entry point;
confirm an association between the received authenticating data and the conveyable container; and
generate a notification of the positional event when the association is confirmed, wherein the positional event comprises at least one of a placement of the commercial product into the volume, and a removal of the commercial product from the volume.

2. The system of claim 1, wherein a sensor included in the one or more sensors is configured to capture an image of a unique identifier positioned on a surface of the commercial product when the commercial product undergoes the positional event.

3. The system of claim 2, wherein in confirming the association the control circuit is further configured to convert the captured image of the unique identifier to machine readable code.

4. The system of claim 1, wherein a sensor included in the at least one or more sensors is configured to capture a weight value of the commercial product when the commercial product undergoes a positional event.

5. The system of claim 1, wherein a sensor included in the at least one or more sensors is configured to capture a wireless identification signal emanating from the commercial product when the commercial product undergoes the positional event.

6. The system of claim 1, wherein a sensor included in the at least one or more sensors is configured to capture geospatial data of the conveyable container when the commercial product undergoes the positional event.

7. The system of claim 1, wherein a sensor included in the one or more sensors is configured to measure an acceleration of the conveyable container, and wherein the control circuit is further configured to generate a second notification when the measured acceleration exceeds a threshold value.

8. The system of claim 1, wherein the conveyable container is further configured to display at least one of: authentication data, the generated notification and information corresponding to confirmation of the association.

9. The system of claim 1, wherein the conveyable container is further configured to emit the generated notification via at least one of: a wireless signal and an audible signal.

10. The system of claim 1, wherein the one or more sensors are configured to be one of: permanently affixed to a surface of the conveyable container and selectively affixed to a surface of the conveyable container.

11. A method for enabling shipping of commercial products, comprising:
receiving, via one or more control circuits, an authenticating data associated with a commercial product when the commercial product undergoes a positional event relative to a volume positioned at a commercial product entry point, wherein the volume is configured to hold one or more commercial products;
confirming, via the one or more control circuits, an association between the received authenticating data and a conveyable container comprising the volume;
generating, via the one or more control circuits, a notification of the positional event;
wherein the positional event is an event selected from a group consisting of: a placement of the commercial product in the volume or a removal of the commercial product from the volume; and
wherein the commercial product entry point is included in a plurality of commercial product entry points positioned proximate to a conveyor.

12. The method of claim 11, wherein the step of receiving the authenticating data comprises capturing one or more images of a unique identifier positioned on a surface of the commercial product when the commercial product undergoes the positional event.

13. The method of claim 12, wherein the step of confirming the association comprises converting the one or more captured images into machine readable code and confirming an association between the machine readable code and the conveyable container.

14. The method of claim 11, wherein the step of receiving the authentication data comprises capturing a weight value of the commercial product when the commercial product undergoes the positional event.

15. The method of claim 11, wherein the step of receiving the authenticating data comprises capturing a wireless identification signal emanating from the commercial product.

16. The method of claim 11, wherein the step of receiving the authenticating data comprises capturing geospatial data associated with the conveyable container when the commercial product undergoes the positional event.

17. The method of claim 11, further comprising generating a second notification when a measured acceleration value of the conveyable container exceeds a threshold value.

18. The method of claim 11, further comprising presenting data on a display positioned proximate to a surface of the conveyable container, wherein the data comprises at least one of: the authentication data, the generated notification and information corresponding to confirmation of the association.

19. The method of claim 11, wherein generating the notification further comprising emitting the generated notification via at least one of: a wireless signal and an audible signal.

20. The method of claim 11, wherein the step of receiving the authenticating data comprises receiving the authenticating data via a sensor, wherein the sensor is one of: permanently affixed relative to the volume and selectively affixed relative to the volume.
